(19) United States
(12) Patent Application Publication
(10) Pub. No.: US 2009/0200359 A1
(43) Pub. Date: Aug. 13, 2009

(54) REDUCING SHEET DISTORTION IN FRICTION STIR PROCESSING

(75) Inventors: Yen-Lung Chen, Troy, MI (US); Manasij Kumar Yadava, Rolla, MO (US); Xiaohong Q. Gayden, West Bloomfield, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., DETROIT, MI (US)

(21) Appl. No.: 12/030,353

(22) Filed: Feb. 13, 2008

(51) Int. Cl. B23K 20/12

(52) U.S. Cl. 228/112.1

(57) ABSTRACT

Local heat may be generated through surfaces of sheet metal workpieces by supporting the workpiece(s) on a hard surfaced anvil and engaging the opposite surface of the workpiece with a rotating, and optionally translating, friction stir tool that is pressed against the work surface. Advantages are realized in friction stir processing (e.g. seam or spot welding) of such sheet metal workpieces by using an anvil with appreciable thermal conductivity, or a liquid cooled anvil body, to suitably cool the site(s) of the workpiece engaged by the friction stir tool to minimize or eliminate distortion of the workpiece.

### TECHNICAL FIELD

This invention pertains to friction stir processing of sheet metal workpieces using a support anvil. More specifically, this invention pertains to adapting a support anvil for increasing heat transfer from a workpiece to reduce thermal and mechanical distortion of a sheet during friction stir processing of sheet metal workpieces. The term “friction stir processing” normally includes linear friction stir welding, friction stir spot welding, and friction stir processing where joining of workpieces is not intended.

### BACKGROUND OF THE INVENTION

In friction stir processing, the end of a rotating tool is pressed in frictional engagement with a surface, or surfaces, of one or more supported workpieces to heat the underlying surface region(s) of the workpieces. The working end of the rotating tool is pressed into contact with the parts to be processed. The workpiece or pieces are supported on a side opposite the applied force of the rotating tool by a member sometimes called an anvil. A friction stir tool-contacted surface of a workpiece is rapidly heated depending primarily on the pressure and rotational speed of the tool for a material processing object. The friction stir tool is formed of a hard and high melting point material that is not softened or adversely affected by the heat generated at the interface of the rotating tool and the engaged workpiece or workpieces. Friction stir processing anvils usually are formed of a hard steel alloy that is unaffected by the friction stir heating of the workpiece(s) pressed against the anvil body.

Where the end of the friction stir tool is substantially flat, the effect of the rotating friction stir tool may be to heat the underlying workpiece(s) with minimal distortion for a thermal processing result. The purpose may be to soften or harden the surface, or to alter the underlying surface microstructure of the workpiece with or without causing phase transformations in the workpiece. Or the purpose may be to form a weld between two or more underlying sheet layers. Where the end of the rotating tool carries an axially extending probe (that is, the probe lies on the axis of rotation of the tool and extends from the end of the tool) the more concentrated force of the rotating probe rapidly plasticizes the contacted surface(s) until the probe is withdrawn or moved away from the plasticized region. Upon cooling, the re-hardened material may form a butt weld between abutting end surfaces of two workpieces or a lap weld between overlying layers of sheet material. In this way a linear friction stir seam weld is made by plunging the probe into the workpieces and moving the probe to progressively form a pattern of temporarily plasticized material. Or one or more friction stir spot welds may be formed by momentarily plunging the rotating probe into overlapping sheets or strips and withdrawing the probe to allow plasticized material to harden through the interface of the layers. A series of such spot welds may be made between two sheets or between different workpieces.

Friction stir processing has been practiced on metals and other materials, such as polymer compositions, that respond in a desired manner to such frictionally generated heat. In general, the rate of heating of these friction stir processes and the temperature attained has been managed by design of the probe or other contacting face of the rotating tool, the pressure between the tool and engaged surface, the rate of rotation of the tool, the rate of translation of the tool (where applicable) and the duration of the frictional engagement.

It would be useful to practice friction stir processing on relatively thin sheets of thermally conductive materials such as aluminum alloys and magnesium alloys. For example, it is often desired to form one or more spot welds between layers of such metal alloy sheets. One exemplary application lies in the formation of a seam weld or a series of spot welds in hemming the peripheries of inner and outer aluminum alloy closure panels for automotive vehicles. In these automotive closure panels, there is usually a layer of adhesive applied between the inner panel and the outer panel. The edge of an aluminum outer sheet panel may be wrapped around a peripheral edge of an aluminum inner sheet panel and a weld formed from the back side of the assembly through two or three sheet layers of the assembled sheet panels. However, it is found that known friction stir processing practices sometimes result in thermal and mechanical distortion in the friction stir welded aluminum sheets. The friction stir heating is local and intense, and heat transfer from the spot weld or linear seam weld sites causes distortion of the cooler surrounding metal. Visible surfaces of the automotive body panels can become marred as a result.

It is an object of the invention to provide a friction stir processing method applicable to such metal sheets that reduces deformation or distortion of surrounding sheet material, especially on the surface of the workpiece opposite the surface of friction stir tool engagement.

### SUMMARY OF THE INVENTION

In friction stir processing a suitable anvil structure supports the workpiece(s) against the applied force of the rotating friction stir tool. In the practice of this invention, the workpieces may often be light metal sheet materials such as aluminum alloy or magnesium alloy vehicle body panels, or other relatively thin metal parts and an anvil is also used to conduct heat from a friction stir processing site. When, for example, a three-layer stack of one millimeter thick aluminum sheets is subjected to friction stir processing, the temperature of plasticized metal may reach 450-470° C. The mass of hot plasticized metal may heat surrounding sheet material so as to reduce its yield strength and enable unwanted deformation. A high conductivity surface of the anvil closely engages a side of the sheet metal workpieces opposite that engaged by the friction stir tool. The anvil is used to remove heat from the work site so as to maintain the contacting workpiece layer at a suitably low temperature (e.g., 300° C. or lower in the case of aluminum alloys) to avoid deformation. In accordance with the invention, an anvil for friction stir processing of sheet metal workpieces is formed of a hard material that also dissipates heat quickly from the sheet material especially at and around the friction stir processing engagement site. For example, an anvil material and structure (which may be internally cooled) is provided so that its heat removal ability into the anvil is greater than an equivalent thermal conductivity of about 40 W/m-° K. at room temperature. Further, in those embodiments in which the anvil side of the workpieces will be a visible surface in a finished product, the anvil is further provided with a suitably smooth surface finish so that the anvil does not damage the visible surface of a friction stir processed article.

In one embodiment of the invention, the anvil may be formed of a hard copper alloy such as an alloy used to form electrodes for electrical resistance welding. Such alloys retain their hardness at elevated temperatures experienced in resistance welding, and such alloys have a relatively high thermal conductivity. For example, the thermal conductivity of Resistance Welder Manufacturer's Association (RWMA) Class 1 copper alloy at room temperature is about 367 W/m-° K. An anvil plate (or other suitable anvil structure shape) of such high thermal conductivity alloy is used to conduct heat from the backside of the friction stir affected workpiece. The anvil serves to increase the temperature differential between the sheet metal workpiece and the anvil. The thin sheet metal workpiece is cooled and thermal and mechanical distortion reduced. In a specific application, the size and shape of the high thermal conductivity anvil body may be determined by experience or during process startup experimentation to suitably cool the sheet metal workpiece(s) during friction stir welding or other friction stir processing. When the anvil is formed, for example, of copper plates, one or more closely fitting plate layers may be used to adjust heat removal from the friction stir processing site.

In another embodiment of the invention, the anvil structure may itself be cooled for temperature management of the friction stir processing site in the sheet materials. For example, a hard steel or hard copper anvil body may be provided with internal passages for circulation of cooling water, flowing air, or other cooling fluid. Thus, the anvil body is cooled so as to maintain the friction stir processing site(s) of the sheet metal workpieces at a temperature range to reduce or eliminate thermal and mechanical deformation of the processed workpieces.

Heretofore, friction stir processing has been managed by consideration of processing parameters such as the shape of the friction stir tool, the force of the tool on the workpiece, the travel speed, and the rate of rotation of the tool against the workpiece. In accordance with embodiments of this invention, an additional and very significant process control method is provided. By increasing and managing the removal of heat from the anvil side of the friction stir setup, thermal and mechanical deformation of the workpieces, especially sheet metal workpieces, may be reduced or eliminated.

Other objects and advantages of the invention will be understood from a further discussion of certain illustrative detailed embodiments of the practice of the invention.

### BRIEF DESCRIPTION OF THE DRAWINGS

FIG. 1 is an oblique view, in cross-section, of a friction stir processing assembly of overlapping sheet metal edges in which the sheet metal layers are pressed between a rotating friction stir tool and an anvil formed of a selected number of high thermal conductivity copper alloy plates for managed removal of heat from the friction stir process site.

FIG. 2 is an oblique view, in cross section, of a friction stir processing assembly of overlapping sheet metal edges in which the sheet metal layers are pressed between a rotating friction stir tool and a water-cooled, high thermal conductivity copper alloy anvil for managed removal of heat from the friction stir process site.

FIG. 3 is an oblique view, in cross-section, of a friction stir processing assembly for forming a linear seam weld to form a hem between edge portions of overlapping aluminum alloy sheets. Such a weld might be formed in joining inner and outer vehicle hood panels.

### DESCRIPTION OF PREFERRED EMBODIMENTS

Sheet distortion during friction stir welding and other friction stir processing has limited the application of these processes for thin sheets, for example, sheets having a thickness in a range of about one-half millimeter to about four millimeters. Often, each sheet layer will be about one millimeter thick. Sheet distortion can occur locally due to plastic deformation under the friction stir tool and in the whole blank caused by non-uniform thermal expansion (due to non-uniform temperature distribution) of the constrained workpiece. High thermal conductivity hard copper anvils and backing plates reduce the peak temperature in the contacting regions of workpiece and anvil. This reduces the plastic distortion of the bottom surface of the work piece (especially thin sheet alloys of the order of one millimeter thickness per layer) and improves the aesthetics of the bottom surface of the welded assembly. Better heat removal not only retains a better strength of the workpiece during welding but also decreases the amount of thermal expansion and residual stresses in the mechanically constrained work piece and therefore the resultant distortion.

This invention pertains to the reduction of sheet deformation during friction stir processing of metal alloy sheets such as, for example, the formation of linear friction stir welds, and friction stir spot welds between layers of such metal sheets. In one embodiment of the invention, hard copper alloy anvils and backing plates are used in friction stir processing of metal alloy sheets such as aluminum or magnesium alloy sheets. The anvil bodies may be formed, for example of one of the copper alloys used for resistance spot welding electrodes (e.g., RWMA Class 1, Class 2, or Class 3 electrode alloys). As an example, RWMA Class 1 copper alloy (UNS C 15000) is a Cu—Zr alloy, nominally containing 0.15 wt. % Zr) These copper alloys have high thermal conductivity, good hardness, and high strength. When such an alloy is used in a suitable anvil shape, the contact between the anvil and workpiece leads to a higher thermal gradient across the workpiece thickness and better heat extraction from the work piece than experienced with conventional steel anvils. Still, these copper alloy anvils suitably support the welding or processing load. Alternatively, an internal cooling fluid channel can be drilled or otherwise formed in steel anvils and steel backing plates to achieve a similar heat transfer effect. Internal cooling fluid channels can also be provided in hard copper alloy anvils and backing plates to further enhance their heat management effect.

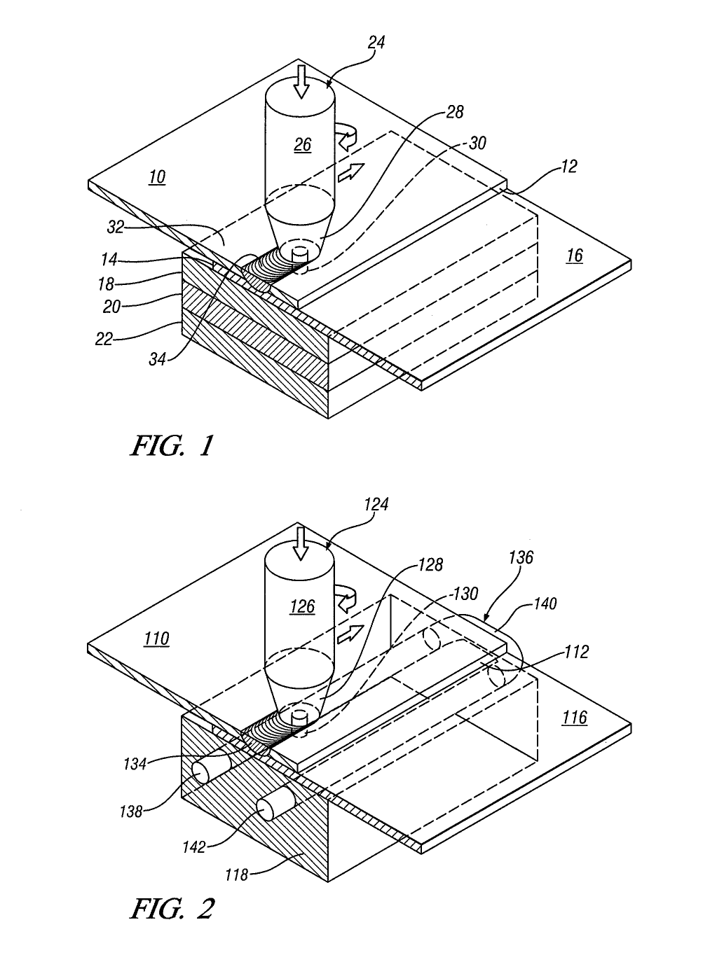

FIG. 1 illustrates an embodiment of the invention in which a linear seam weld is formed between overlapping aluminum alloy sheets by a friction stir welding process. A first rectangular aluminum alloy sheet 10 has an edge 12 overlying and overlapping edge 14 of a second rectangular sheet 16. The thickness of sheets 10, 16 may often be in the range from about one-half millimeter to about four millimeters. In this example, sheets 10, 16 are shown to be of the same thickness and their thickness is somewhat exaggerated to illustrate the friction stir welding process. Also in this example, edges 12 and 14 are parallel and a linear seam weld is to be formed in a line generally parallel to sheet edges 12, 14 and situated in between them. A linear seam weld can also be formed along edge 12, joining sheets 10 and 16 and sealing the interface between sheets 10 and 16 at edge 12. The portions to be welded of overlapping sheets 10, 16 are placed on a stack of three rectangular copper alloy anvil plates 18, 20, 22 that, in this example, are the same size and shape. The assembly of overlapping sheets 10, 16 is secured for the friction stir processing by a suitable fixture or clamping means, not shown.

In FIG. 1, the anvil plates 18, 20, 22 extend beyond the edges 12, 14 of the sheets 10, 16. In this example, a stack of three anvil plates 18, 20, 22 is employed. However, a single anvil plate, or a different number of plates, may be employed to obtain suitable heat dissipation from the friction stir weld site on the thin aluminum sheets. Sometimes, for example, greater anvil mass is desired when friction stir processing operations are continuous and ongoing and the temperature of the anvil may increase.

A friction stir tool 24 with round cylindrical tool body 26 and truncated conical end section 28 carrying a cylindrical probe 30 is used in making a seam weld. Friction stir tool 24 is gripped in the chuck of a powered friction stir welding machine, not shown, that rotates friction stir tool 24 around a longitudinal axis at the center of round tool body 26, conical end section 28 and axial probe 30. For thin sheet material, axial probe 30 can be very short, about the thickness of the top sheet, sheet 10 in this example, or even be eliminated. The friction stir machine positions friction stir tool 24 over overlapping sheets 10, 16 with probe 30 directed nearly perpendicularly at upper surface 32 of upper sheet 10. In this example, the friction stir machine rotates friction stir tool 24 as indicated by the curved circumferential arrow in FIG. 1 and presses the end of probe 30 against surface 32 of sheet 10 as indicated by the vertical arrow. A typical welding condition for the assembly in FIG. 1 of a one millimeter thick aluminum alloy sheet on a one millimeter aluminum alloy sheet includes a rotational speed of 2000 rpm, travel speed of 15 mm/s, force of 5 kN, and a push angle 2°.

As rotating probe 30 of friction stir tool 24 is pressed into sheet 10 it plasticizes the underlying and adjacent aluminum alloy material and penetrates through the thickness of sheet 10 into sheet 16. In the formation of a seam weld, as is illustrated in FIG. 1, friction stir tool 24 with revolving probe 30 penetrating in the workpiece material is moved in a linear path generally parallel to sheet edges 12, 14 to progressively heat and plasticize the metal engaged by friction stir tool 24. As the rotating friction stir tool 24 is translated along its predetermined path, the plasticized metal left behind cools and re-hardens. This re-hardened metal is illustrated schematically at 34 as a partially formed weld seam. In this example, probe 30 penetrates through the thickness of top sheet 10 and into the top one-quarter or so of the thickness of underlying sheet 16. After the rotating friction stir tool 24 has been moved across the whole width of the overlapping sheets 10, 16, the linear weld seam 34 extends across the width of sheets 10, 16.

In this embodiment, a stack of three copper plates 18, 20, 22 are selected to extract sufficient heat from the friction stir affected region of the assembly of overlapping sheets. The thermal conductivity and mass of the three plates (or a different number or size of plates) is predetermined by experiment or other analytical means to facilitate friction stir welding of sheets 10, 16 with minimal distortion or marring of the overlapping sheet assembly.

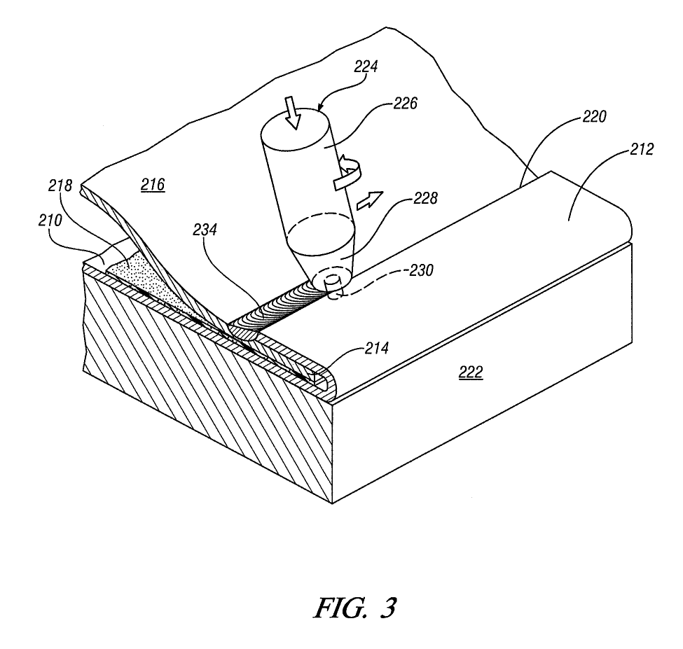

In FIG. 2, a like friction stir tool 124 (with like round cylindrical tool body 126 and truncated conical end section 128 and axial cylindrical probe 130) is used in a like manner to form a like linear seam weld 134 in like overlapping sheets 1 10, 1 16. However, in this embodiment, hard copper alloy (or steel alloy) anvil body 118 is liquid cooled for adjustable temperature management in the friction stir weld site area (at and around weld seam 134). Anvil 118 has, for example, one or more internal U-shaped coolant flow passages 136 for temperature control of anvil body 118. A temperature-controlled fluid, such as water, may be pumped into one drilled leg 138 of the U-shaped passage 136 in anvil body 118, through return passage 140, and back through the other parallel cooling leg 142 bored through anvil 118. The temperature, or temperature range, of the cooling liquid or gas may be determined to cool the assembled sheets 110, 116 in the region of seam weld 134 to reduce or eliminate distortion in the sheet material of the welded assembly.

The formation of seam welds is illustrated in FIGS. 1 and 2. But a friction stir processing machine may be operated to form a spot weld, or group of spot welds in overlapping sheet layers. Also, friction stir processing operations (such as those illustrated in FIGS. 1 and 2) may be setup for a one-time process on assembled sheets. Or, as is often more likely, the operation may be set up for a succession of spot welds, seam welds formed in individual sheet assemblies and/or a continuous succession of such assemblies.

FIG. 3 illustrates the use of anvil cooling in making a friction stir hem weld between two sheet metal workpieces, as in joining inner and outer vehicle hood panels.

FIG. 3 is a schematic illustration of a portion of an aluminum alloy sheet panel 210, for example a vehicle hood outer panel, with a peripheral portion 212 folded over an edge 214 of a second aluminum alloy sheet 216 (e.g. a vehicle hood inner panel). An adhesive layer 218 has been applied to a portion of the upper surface (as positioned in FIG. 3) of sheet 210. Adhesive layer 218 bonds an end portion of the top surface of sheet 210 to an end portion of the bottom surface of enclosed sheet 216. The folded-over peripheral portion 212 of sheet 210 is bent so that it presses tightly against the top surface of sheet 216. Adhesive layer 218 will form an adhesive bond between facing surface portions of sheets 210 and 216.

A friction stir seam weld is to be formed between the peripheral edge 220 of sheet 210 and an underlying portion of sheet 216. An assembly of sheets 210 and 216 is placed and secured on anvil 222 for the purpose of forming a seam weld. Anvil 222 is made of a high conductivity copper alloy having a contacting surface area with the bottom side of sheet 210 and a thickness and mass for heat removal from hemmed sheets 210, 216 and interposed adhesive layer 218 during the friction stir welding operation.

A friction stir tool 224 with round cylindrical tool body 226 and truncated conical end section 228 carrying a cylindrical probe 230 is used in making a seam weld. Friction stir tool 224 is gripped in the chuck of a powered friction stir welding machine, not shown, that rotates friction stir tool 224 around a longitudinal axis at the center of round tool body 226, conical end section 228 and axial probe 230. The friction stir machine positions friction stir tool 224 over overlapping sheets 210, 216 with probe 230 directed at a predetermined angle at the edge 220 of sheet 210 and underlying upper surface of sheet 216. In this example, the seam weld is to be formed by progressive plasticization of a portion of the edge 220 material of aluminum alloy sheet 210 and the immediately underlying material of sheet 216. The friction stir machine rotates friction stir tool 224 as indicated by the curved circumferential arrow in FIG. 3 and presses the end of probe 230 against edge 220 material of sheet 210 and into sheet 216 as indicated by the vertical arrow. A typical welding condition for the assembly in FIG. 3 of a one millimeter thick aluminum alloy sheet on a one millimeter aluminum alloy sheet includes a rotational speed of 2000 rpm, travel speed of 15 mm/s, force of 5 kN, a work angle of 3° and a push angle of 3°.

As rotating probe 230 of friction stir tool 224 is pressed into edge 220 and underlying sheet 216, it plasticizes the underlying and adjacent aluminum alloy material and penetrates through the thickness of the edge material of sheet 210 and into sheet 216. In the formation of a seam weld, as is illustrated in FIG. 3, friction stir tool 224 with revolving probe 230 penetrating in the workpiece material is moved in a linear path along sheet edge 220 to progressively heat and plasticize the metal engaged by friction stir tool 224. As the rotating friction stir tool 224 is translated along its predetermined path, the plasticized metal left behind cools and re-hardens. This re-hardened metal is illustrated schematically at 234 as a partially formed weld seam. In this example, probe 230 penetrates through the edge thickness of sheet 210 and into the top one-quarter or so of the thickness of underlying sheet 216. After the rotating friction stir tool 224 has been moved across the whole width of the overlapping sheets 210, 216, the linear weld seam 234 extends across the width of the edge hemmed sheets. Although in FIG. 3 friction stir welding is done along edge 220, a friction stir weld may be made approximately parallel to and in between edge 220 and edge 214 as an alternative embodiment. In another alternative embodiment, an adhesive is not used and the friction stir weld penetrates through two sheet metal layers into the third layer.

In this example, anvil 222 must provide suitable thermal conductivity and be sized and shaped, and provide suitable heat transfer from the seam weld site 234 between aluminum sheets 210 and 216 which also includes a thin layer of low thermal conductivity organic polymer-containing adhesive composition 218. Surface-to-surface contact between anvil 222 and the bottom side of sheet 210 must accommodate such heat transfer across the interface between the contacting surfaces. The temperature in the friction stir plasticized zone may reach temperatures of about 450° C. to about 470° C. Where the aluminum sheets 210, 216 are formed of AA6016 aluminum alloy about one millimeter thick it is preferred to adapt anvil 222 so as to maintain the top surface of the bottom portion of sheet 210 at a temperature below about 300° C. Also, the bottom side of sheet 210 may be the visible surface of a vehicle hood outer panel and the engagement of anvil 222 with sheet 210 must not mar the finish of sheet 210.

Thus, the improvement of thermal conduction between a friction stir process anvil and engaging workpiece(s) provides a new and independent way of controlling the temperature of the processed zone apart from friction stir tool rotation rate and travel speed. Such high conductivity anvils enhance the window of process parameters. This can be a very important tool to limit excessive heat build-up in friction stir processing, especially friction stir welding, of certain sheet metal workpieces and make the weld feasible. The improvement of thermal conduction between anvil and workpiece will make possible the application of friction stir processing to thin sheets for applications where surface flatness is important. It can also make welding of dissimilar materials (e.g., aluminum to magnesium) feasible, where incipient melting is the limiting factor. It will also allow higher rotation rate and faster travel speed hence shorter production time for friction stir processing, especially welding, of materials, for which the process is limited by excessive heat build- up during the process.

In some instances an originally smooth surface of a sheet metal piece must not be distorted or marred after friction stir processing to preserve the visual appearance of a product. This is the case with the outer and visible surface of a hood or door of an automobile. In addition to using the above heat extraction method and controlling the welding parameters, the surface roughness of the anvil needs to be less than or comparable to the surface roughness of the sheet metal. For example, an anvil surface roughness (Ra) of less than 1.0 μm was found to be able to maintain a Class A surface finish after painting from a bare aluminum sheet with a Ra of 0.46 μm. It is believed that an anvil surface roughness up to about 1.5 μm can be used and maintain a Class A surface finish after painting of the anvil-contacted sheet surface.

Practices of the invention have been described using specific illustrative embodiments, but the invention is not limited to the content of such illustrations.

1. A method of conducting friction stir processing at a friction stir processing site on a workpiece, the workpiece comprising at least one layer of sheet metal, the at least one layer of sheet metal having a first surface for engagement under an applied force by a working surface of a rotating fiction stir tool and a second surface to be supported by an anvil against the force of the friction stir tool, the method comprising:
pressing the working surface of the rotating friction stir tool against the first surface of the workpiece while engaging the second surface of the workpiece with an anvil in opposition to the pressing force of the rotating friction stir tool;
the pressing force of the friction stir tool and the rate of rotation of the friction stir tool, and the translation of the friction stir tool, if any, producing a desired process heating effect in the workpiece at the processing site; and
using the anvil to remove heat from the processing site at the second surface of the workpiece to minimize thermal and mechanical distortion of the sheet metal workpiece, the anvil comprising at least one of (i) a high conductivity metal alloy in contact with the second surface and (ii) internal or external cooling means.

2. A method of conducting friction stir processing as recited in claim 1 in which the workpiece comprises aluminum alloy or magnesium alloy sheet metal at the friction stir processing site.

3. A method of conducting friction stir processing as recited in claim 1 in which the anvil comprises a copper alloy material portion in contact with the second surface and the material portion is sized and shaped for removing heat to minimize thermal and mechanical distortion of the workpiece.

4. A method of conducting friction stir processing as recited in claim 1 in which the anvil comprises a steel alloy material portion in contact with the second surface and the steel alloy material portion is cooled with a flowing fluid coolant for removing heat to minimize thermal and mechanical distortion of the workpiece.

5. A method of conducting friction stir processing as recited in claim 1 in which the anvil comprises a copper alloy material portion in contact with the second surface and the copper alloy material portion is cooled with a flowing fluid coolant for removing heat to minimize thermal and mechanical distortion of the workpiece.

6. A method of conducting friction stir processing as recited in claim 1 in which the friction stir tool has a probe on its working surface for penetrating at least the first surface of the workpiece to form plasticized metal in the workpiece for forming a weld.

7. A method of conducting friction stir processing as recited in claim 1 in which the friction stir tool has no protruding probe on its working surface.

8. A method of conducting friction stir processing as recited in claim 6 in which the friction stir tool is actuated to form at least one spot weld in the workpiece.

9. A method of conducting friction stir processing as recited in claim 6 in which the friction stir tool is actuated to form at least one linear seam weld in the workpiece.

10. A method of conducting friction stir processing as recited in claim 1 in which the friction stir tool has a working surface for selectively heating the first surface of the workpiece at the friction stir processing site to produce a thermally-induced or thermomechanically-induced transformation of the metal at the processing site.

11. A method of conducting friction stir processing as recited in claim 1 in which the anvil is formed of at least one plate of a copper alloy, the alloy having a hardness and thermal conductivity selected for the friction stir processing.

12. A method of conducting friction stir processing as recited in claim 1 in which the anvil is formed of at least one plate of a copper alloy, the alloy having a hardness and thermal conductivity selected for the friction stir processing and the number of copper plates being more than one selected for the friction stir processing.

13. A method of conducting friction stir processing as recited in claim 1 in which the anvil is water cooled.

14. A method of conducting friction stir processing as recited in claim 1 in which the processing site comprises first, second, and third sheet metal layers with an adhesive layer between the second and third sheet layers, the friction stir processing tool plasticizing and joining metal in the first and second layers, and the anvil engaging a side of the third layer opposite the adhesive layer.

15. A method of conducting friction stir processing as recited in claim 1 in which the processing site comprises first, second, and third sheet metal layers, the friction stir processing tool plasticizing and joining metal in the first, second, and third layers, and the anvil engaging a side of the third layer opposite the contacting surface of the second and third layers.

16. A method of conducting friction stir processing as recited in claim 1 in which the anvil has a surface roughness no greater than the surface roughness of the workpiece.

17. A method of conducting friction stir processing as recited in claim 1 in which the anvil has a surface roughness no greater than about 1.5 micrometers.

18. A method of conducting friction stir processing as recited in claim 1 in which the workpiece comprises steel sheet metal at the friction stir processing site.

19. A method of conducting friction stir processing as recited in claim 1 in which the workpiece comprises an aluminum alloy sheet with a surface engaging the anvil and the anvil is used to remove heat from the workpiece so that the temperature in the aluminum sheet is about 300° C. or lower.
